(19) United States
(12) Patent Application Publication
(10) Pub. No.: US 2009/0070117 A1
(43) Pub. Date: Mar. 12, 2009

(54) Interpolation method

(75) Inventor: Kaori Endo, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/230,873

(22) Filed: Sep. 5, 2008

(30) Foreign Application Priority Data
Sep. 7, 2007 (JP) 2007-233273

(51) Int. Cl. G10L 13/00

(52) U.S. Cl. 704/265; 704/E13.001

(57) ABSTRACT

According to an aspect of an embodiment, a method for interpolating a partial loss of an audio signal including a sound signal component and a background noise component in transmission thereof, the method comprising the steps of: calculating frequency characteristic of the background noise in the audio signal; extracting the sound signal component from the audio signal; generating pseudo noise by applying the frequency characteristic of the background noise included in the audio signal to white noise; and generating an interpolation signal by combining the pseudo noise with the extracted sound signal component included in the audio signal to supersede the partial loss of the audio signal.

### BACKGROUND OF THE INVENTION

1. Field of the Invention

The present invention relates to an interpolation method performed in the transmission of sound in a packet-switching network.

2. Description of the Related Art

In the transmission of audit signals via VoIP (Voice over Internet Protocol), packet loss often occurs. The occurrence of the packet loss causes the intermittence of sound, and thus substantially deteriorates the sound quality. To prevent such deterioration of the sound quality, a concealment process has been performed which conceals the loss of an audio signal by performing interpolation for the lost packet. Specifically, the interpolation process for the lost packet is based on ITU-T (International Telecommunication Union Telecommunication Standardization Sector) Recommendation G.711 Appendix 1. The interpolation process based on G.711 Appendix 1 is a process of performing interpolation for the packet loss by calculating the period of a signal immediately preceding the lost packet and repeating the signal with the calculated period while gradually reducing the amplitude of the signal.

In conventional interpolation processes for the packet loss, such as the one based on G.711 Appendix 1, however, there is an issue of abnormal sound occurring due to an unnatural period generated when the signal immediately preceding the packet loss is a signal having a small periodicity, such as the signal of a consonant, background noise, and so forth. An example of the conventional interpolation processes is disclosed in the publication of International Patent Application Publication No. 2004-068098.

### SUMMARY

According to an aspect of an embodiment, a method for interpolating a partial loss of an audio signal including a sound signal component and a background noise component in transmission thereof, the method comprising the steps of: calculating frequency characteristic of the background noise in the audio signal; extracting the sound signal component from the audio signal; generating pseudo noise by applying the frequency characteristic of the background noise included in the audio signal to white noise; and generating an interpolation signal by combining the pseudo noise with the extracted sound signal component included in the audio signal to supersede the partial loss of the audio signal.

### BRIEF DESCRIPTION OF THE DRAWINGS

FIG. 1 is a configuration diagram of an information processing device according to one of embodiments of the present invention;

FIG. 2 is a configuration diagram of an information processing device according to another one of the present embodiments;

FIG. 3 is a configuration diagram of an information processing device according to another one of the present embodiments;

FIG. 4 is a configuration diagram of an information processing device according to another one of the present embodiments;

FIG. 5 is a configuration diagram of an information processing device according to another one of the present embodiments;

FIG. 6 is a configuration diagram of an information processing device according to another one of the present embodiments;

FIG. 7 is a configuration diagram of an information processing device according to another one of the present embodiments;

FIG. 8 is a flowchart of an interpolation process performed by the information processing devices according to the present embodiments;

FIG. 9 is a flowchart illustrating a processing procedure for calculating the frequency characteristic of background noise performed by analysis unit according to the present embodiments;

FIG. 10 is a flowchart of a procedure for calculating a sound component performed by the analysis unit according to one of the present embodiments;

FIG. 11 is a flowchart of a procedure for calculating the envelope of sound and the sound source of the sound performed by the analysis unit according to another one of the present embodiments;

FIG. 12 is a flowchart of a procedure for calculating the envelope pattern of the sound performed by the analysis unit according to another one of the present embodiments;

FIG. 13 is a flowchart of a procedure for generating pseudo sound performed by pseudo sound generation unit according to one of the present embodiments;

FIG. 14 is a schematic diagram illustrating a connection relationship between repeating signal segments according to one of the present embodiments;

FIG. 15 is a flowchart of a procedure for generating the pseudo sound performed by pseudo sound generation unit according to another one of the present embodiments;

FIG. 16 is a flowchart of a procedure for generating the pseudo sound performed by pseudo sound generation unit according to another one of the present embodiments;

FIG. 17 is a flowchart illustrating a procedure for generating pseudo noise performed by pseudo noise generation unit according to one of the present embodiments;

FIG. 18 is a flowchart of a procedure for generating the pseudo noise performed by pseudo noise generation unit according to another one of the present embodiments;

FIG. 19 is a flowchart of a procedure for generating an output signal performed by output signal generation unit according to the present embodiments;

FIG. 20 is a flowchart illustrating a first procedure for calculating the amplitude coefficient performed by output signal generation unit according to the present embodiments;

FIG. 21 is a flowchart illustrating a second procedure for calculating the amplitude coefficient performed by the output signal generation unit according to the present embodiments; and

FIG. 22 is a flowchart illustrating a process for determining the deterioration of the pseudo sound performed by the output signal generation unit according to the present embodiments.

### DESCRIPTION OF THE PREFERRED EMBODIMENT

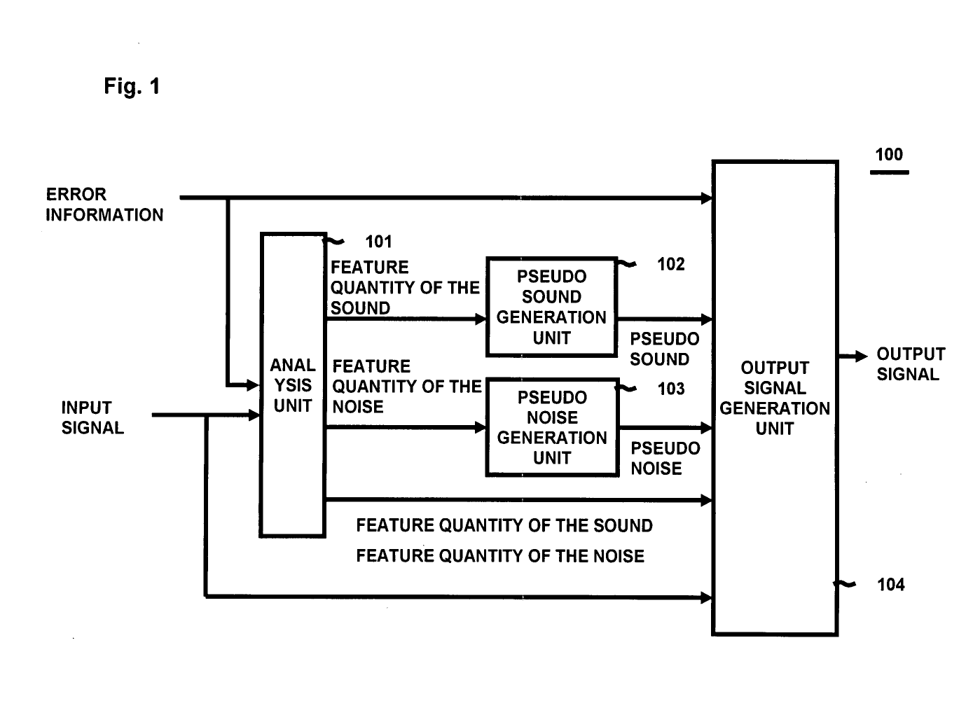

In embodiments of the present invention, information processing devices 100 to 700 perform interpolation for an audio signal lost by a transmission error occurring in VoIP or the like. Functional configurations of the information processing devices 100 to 700 are illustrated in FIGS. 1 to 7.

The information processing devices 100 to 700 calculate pseudo sound of sound included in an input signal and pseudo noise imitating background noise included in the input signal. The information processing devices 100 to 700 perform interpolation for a packet loss by using an interpolation signal formed by the combination of the pseudo sound and the pseudo noise. Further, the information processing devices 100 to 700 can separately control the pseudo sound and the pseudo noise. Accordingly, the information processing devices 100 to 700 can generate an interpolation signal having high sound quality. The signal loss for which the interpolation is performed by the information processing devices 100 to 700 according to the present embodiments includes, for example, a packet loss caused by congestion of a network, an error occurring on a network line, and an encoding error occurring in encoding an audio signal.

With reference to FIGS. 1 to 7, an overview of functions of the information processing devices 100 to 700 will be described below.

### Configuration Diagram of Information Processing Device 100

FIG. 1 is a configuration diagram of the information processing device 100 according to one of the present embodiments.

The information processing device 100 is constituted by analysis unit 101, pseudo sound generation unit 102, pseudo noise generation unit 103, and output signal generation unit 104. Furthermore, the information processing device 100 includes a receiving unit for receiving an audio signal and an output unit for outputting an interpolation signal, and the receiving unit and the output unit are not shown in FIG. 1. Information processing device 200 to 700 includes a receiving unit and an output unit as well and each receiving unit and output unit are not shown in FIGS. 1 to 7. The information processing device 100 is also able to perform a process for interpolating the audio signal in a firmware executed on a CPU mounted on the information processing device 100. The information processing devices 200 to 700 are able to perform a process for interpolating the audio signal in a firmware executed on a CPU as well.

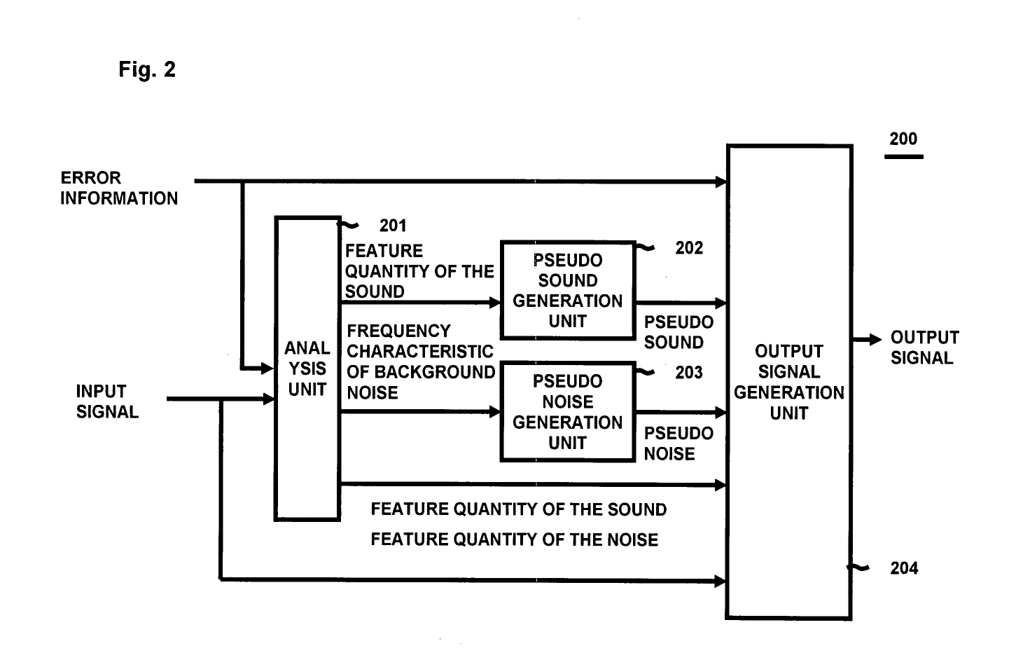

The analysis unit 101 calculates the feature quantity of sound and the feature quantity of noise on the basis of error information and an input signal of a normal section input from outside the information processing device 100. Herein, the error information refers to the information representing the section in which the packet loss has occurred in the transmission of sound. The feature quantity of the sound includes, for example, a sound component of the audio signal, the envelope of the sound component, and the pattern of change in the envelope of the sound component. Further, the feature quantity of the background noise includes, for example, the frequency characteristic of the background noise. Specific examples of the feature quantity of the sound and the feature quantity of the background noise will be described in the description of the information processing devices 200 to 700 illustrated in FIGS. 2 to 7.

Then, the analysis unit 101 inputs the feature quantity of the sound to the pseudo sound generation unit 102. The pseudo sound generation unit 102 generates the pseudo sound on the basis of the feature quantity of the sound.

Further, the analysis unit 101 inputs the feature quantity of the noise to the pseudo noise generation unit 103. The pseudo noise generation unit 103 generates the pseudo noise on the basis of the feature quantity of the noise.

The pseudo sound generation unit 102 inputs the pseudo sound to the output signal generation unit 104. The pseudo noise generation unit 103 inputs the pseudo noise to the output signal generation unit 104. Further, the analysis unit 101 inputs the feature quantity of the sound and the feature quantity of the noise to the output signal generation unit 104. The output signal generation unit 104 acquires the error information and the input signal from outside the information processing device 100. Then, the output signal generation unit 104 generates an output signal. Configuration diagram of information processing device 200

FIG. 2 is a configuration diagram of the information processing device 200 according to one of the present embodiments.

The information processing device 200 is constituted by analysis unit 201, pseudo sound generation unit 202, pseudo noise generation unit 203, and output signal generation unit 204.

The analysis unit 201 calculates the feature quantity of the sound and the feature quantity of the noise on the basis of the error information and the input signal of the normal section input from outside the information processing device 200.

Then, the analysis unit 201 inputs the feature quantity of the sound to the pseudo sound generation unit 202. The pseudo sound generation unit 202 generates the pseudo sound on the basis of the feature quantity of the sound.

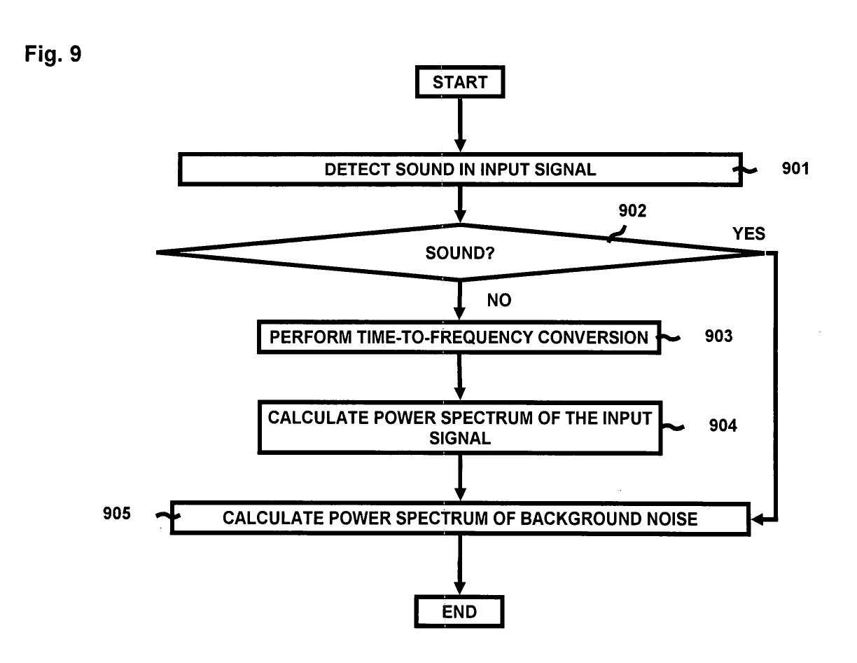

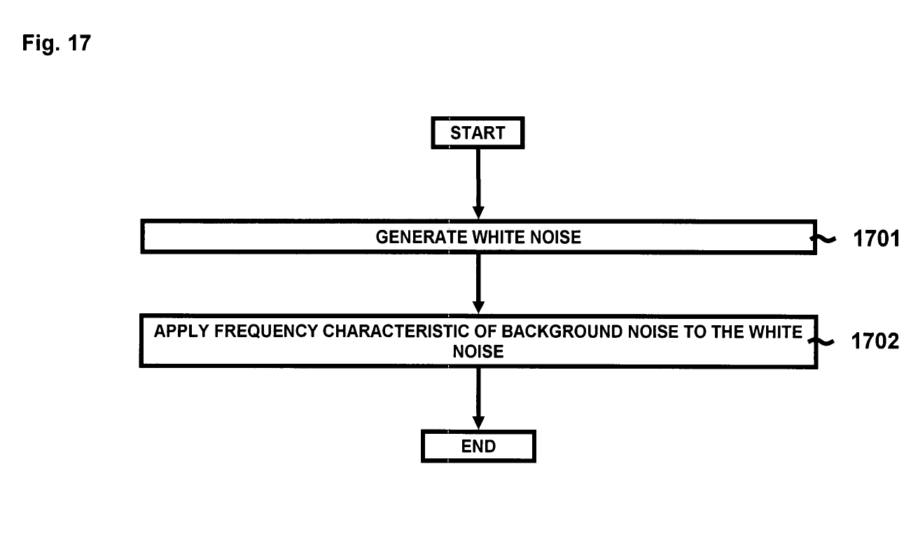

Further, the analysis unit 201 inputs the frequency characteristic of the background noise to the pseudo noise generation unit 203. The frequency characteristic of the background noise include, for example, the power spectrum, the impulse response, and the filter coefficient of the background noise. Herein, the analysis unit 201 calculates the frequency characteristic of the background noise in accordance with a processing procedure illustrated in FIG. 9. The pseudo noise generation unit 203 generates the pseudo noise on the basis of the frequency characteristic of the background noise. For example, the pseudo noise generation unit 203 generates white noise. Then, the pseudo noise generation unit 203 generates the pseudo noise by applying the frequency characteristic of the background noise to the white noise. Alternatively, the pseudo noise generation unit 203 may be configured to previously hold the white noise. Herein, the pseudo noise generation unit 203 generates the pseudo noise in accordance with a processing procedure illustrated in FIG. 17.

The pseudo sound generation unit 202 inputs the pseudo sound to the output signal generation unit 204. The pseudo noise generation unit 203 inputs the pseudo noise to the output signal generation unit 204. Further, the analysis unit 201 inputs the feature quantity of the sound and the feature quantity of the noise to the output signal generation unit 204. The output signal generation unit 204 acquires the error information and the input signal from outside the information processing device 200. Then, the output signal generation unit 204 generates the output signal.

### Configuration Diagram of Information Processing Device 300

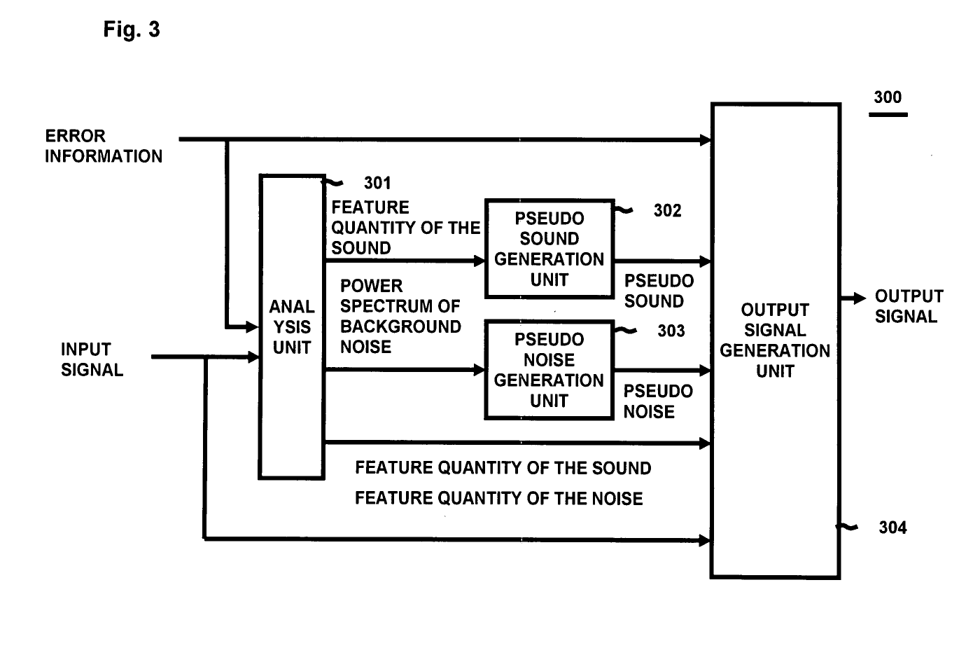

FIG. 3 is a configuration diagram of the information processing device 300 according to one of the present embodiments.

In the information processing device 300, analysis unit 301 specifically calculates the power spectrum of the background noise as the feature quantity of the noise.

The information processing device 300 is constituted by the analysis unit 301, pseudo sound generation unit 302, pseudo noise generation unit 303, and output signal generation unit 304.

The analysis unit 301 calculates the feature quantity of the sound and the power spectrum of the background noise on the basis of the error information and the input signal of the normal section input from outside the information processing device 300. The analysis unit 301 calculates the power spectrum of the background noise in accordance with the processing procedure illustrated in FIG. 9.

Then, the analysis unit 301 inputs the feature quantity of the sound to the pseudo sound generation unit 302. The pseudo sound generation unit 302 generates the pseudo sound on the basis of the feature quantity of the sound.

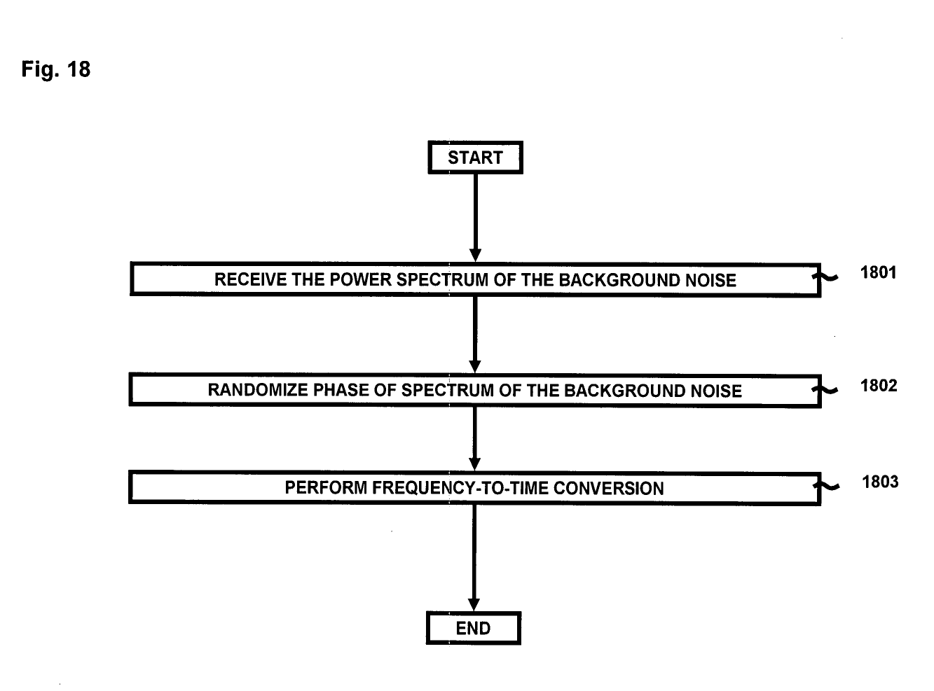

Further, the analysis unit 301 inputs the power spectrum of the background noise to the pseudo noise generation unit 303. The pseudo noise generation unit 303 generates the pseudo noise by providing a random phase to the power spectrum of the background noise and calculating a signal of the time domain through frequency-to-time conversion. Specifically, the pseudo noise generation unit 303 generates the pseudo noise in accordance with a processing procedure illustrated in FIG. 18.

The pseudo sound generation unit 302 inputs the pseudo sound to the output signal generation unit 304. The pseudo noise generation unit 303 inputs the pseudo noise to the output signal generation unit 304. Further, the analysis unit 301 inputs the feature quantity of the sound and the feature quantity of the noise to the output signal generation unit 304. The output signal generation unit 304 acquires the error information and the input signal from outside the information processing device 300. Then, the output signal generation unit 304 generates the output signal.

### Configuration Diagram of Information Processing Device 400

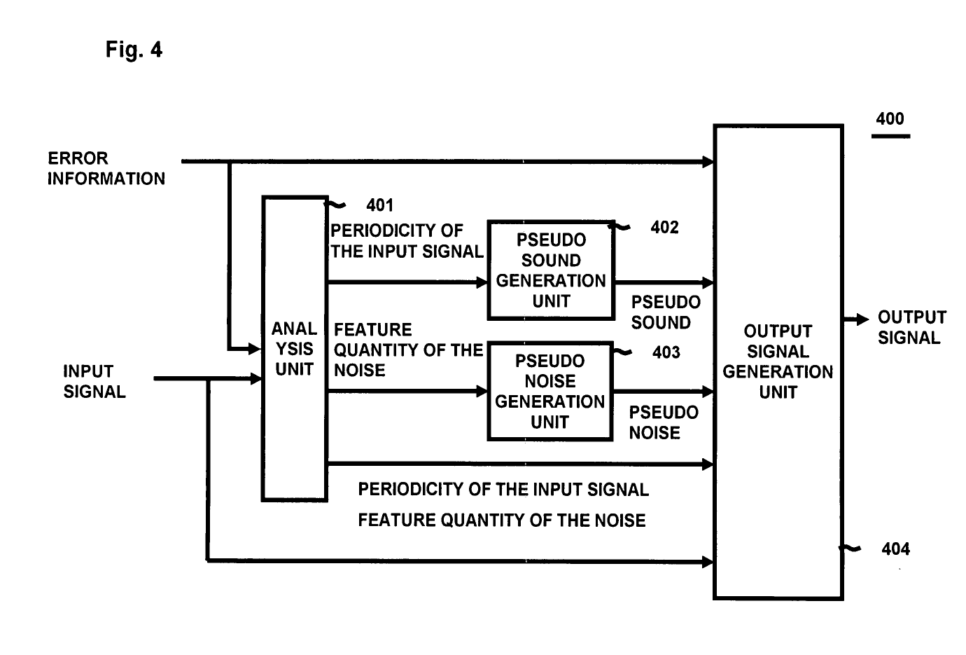

FIG. 4 is a configuration diagram of the information processing device 400 according to one of the present embodiments.

In the information processing device 400 according to the present embodiment, analysis unit 401 calculates the periodicity of the input signal.

The information processing device 400 is constituted by the analysis unit 401, pseudo sound generation unit 402, pseudo noise generation unit 403, and output signal generation unit 404. The information processing device 400 generates the pseudo sound by repeating the input signal with the length of an integral multiple of the period of the input signal.

The analysis unit 401 calculates the periodicity of the input signal and the feature quantity of the noise on the basis of the error information and the input signal of the normal section input from outside the information processing device 400.

Then, the analysis unit 401 inputs the input signal and the periodicity of the input signal to the pseudo sound generation unit 402. The analysis unit 401 calculates the autocorrelation coefficient of the input signal from Formula (F3). The analysis unit 401 calculates, as the period, the length of a displacement position of the signal for maximizing the autocorrelation coefficient. The procedure for calculating the periodicity will be described later.

On the basis of the input signal and the periodicity of the input signal, the pseudo sound generation unit 402 generates the pseudo sound by repeating the input signal with the length of the integral multiple of the period. Further, the analysis unit 401 inputs the feature quantity of the noise to the pseudo noise generation unit 403. The pseudo noise generation unit 403 generates the pseudo noise on the basis of the feature quantity of the noise.

The pseudo sound generation unit 402 inputs the pseudo sound to the output signal generation unit 404. The pseudo noise generation unit 403 inputs the pseudo noise to the output signal generation unit 404. Further, the analysis unit 401 inputs the periodicity of the input signal and the feature quantity of the noise to the output signal generation unit 404. The output signal generation unit 404 acquires the error information and the input signal from outside the information processing device 400. Then, the output signal generation unit 404 generates the output signal.

### Configuration Diagram of Information Processing Device 500

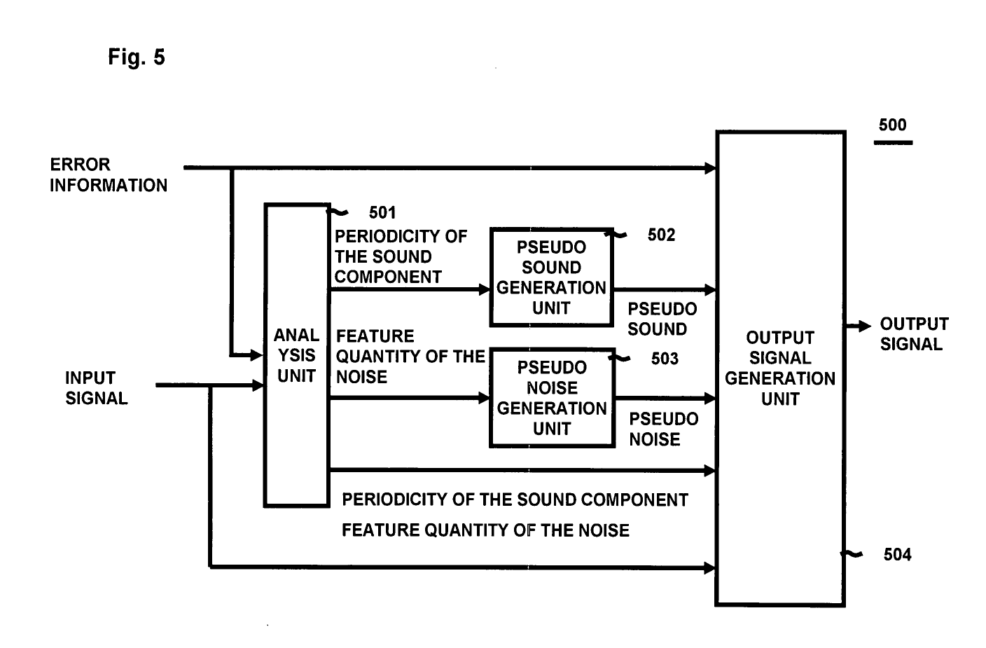

FIG. 5 is a configuration diagram of the information processing device 500 according to one of the present embodiments.

The information processing device 500 is constituted by analysis unit 501, pseudo sound generation unit 502, pseudo noise generation unit 503, and output signal generation unit 504.

The information processing device 500 generates the pseudo sound by repeating the sound component included in the input signal with the length of an integral multiple of the period of the sound component.

The analysis unit 501 calculates the sound component included in the input signal, the periodicity of the sound component, and the feature quantity of the noise on the basis of the error information and the input signal of the normal section input from outside the information processing device 500.

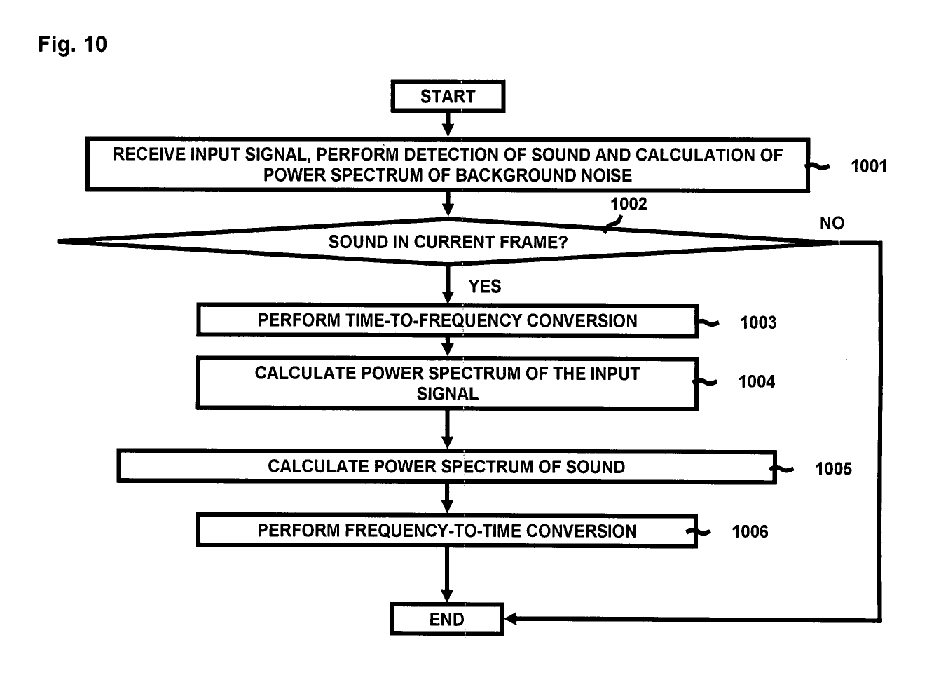

Then, the analysis unit 501 inputs the sound component and the periodicity of the sound component to the pseudo sound generation unit 502. The pseudo sound generation unit 502 generates the pseudo sound by repeating the sound component with the length of the integral multiple of the period of the sound component. The analysis unit 501 calculates the sound component in accordance with a procedure for calculating the sound component illustrated in FIG. 10. Further, the analysis unit 501 calculates the autocorrelation coefficient of the sound component from Formula (F3). The analysis unit 501 calculates, as the period of the sound component, the length of a displacement position of the signal for maximizing the autocorrelation coefficient.

Further, the analysis unit 501 inputs the feature quantity of the noise to the pseudo noise generation unit 503. The pseudo noise generation unit 503 generates the pseudo noise on the basis of the feature quantity of the noise.

The pseudo sound generation unit 502 inputs the pseudo sound to the output signal generation unit 504. The pseudo noise generation unit 503 inputs the pseudo noise to the output signal generation unit 504. Further, the analysis unit 501 inputs the periodicity of the sound component and the feature quantity of the noise to the output signal generation unit 504. The output signal generation unit 504 acquires the error information and the input signal from outside the information processing device 500. Then, the output signal generation unit 504 generates the output signal.

### Configuration Diagram of Information Processing Device 600

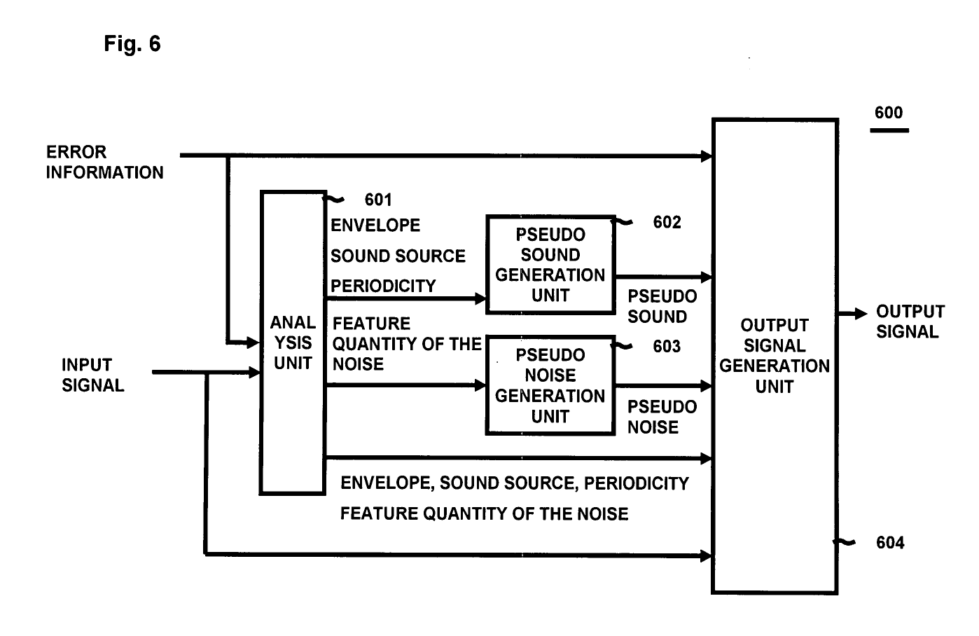

FIG. 6 is a configuration diagram of the information processing device 600 according to one of the present embodiments.

The information processing device 600 is constituted by analysis unit 601, pseudo sound generation unit 602, pseudo noise generation unit 603, and output signal generation unit 604.

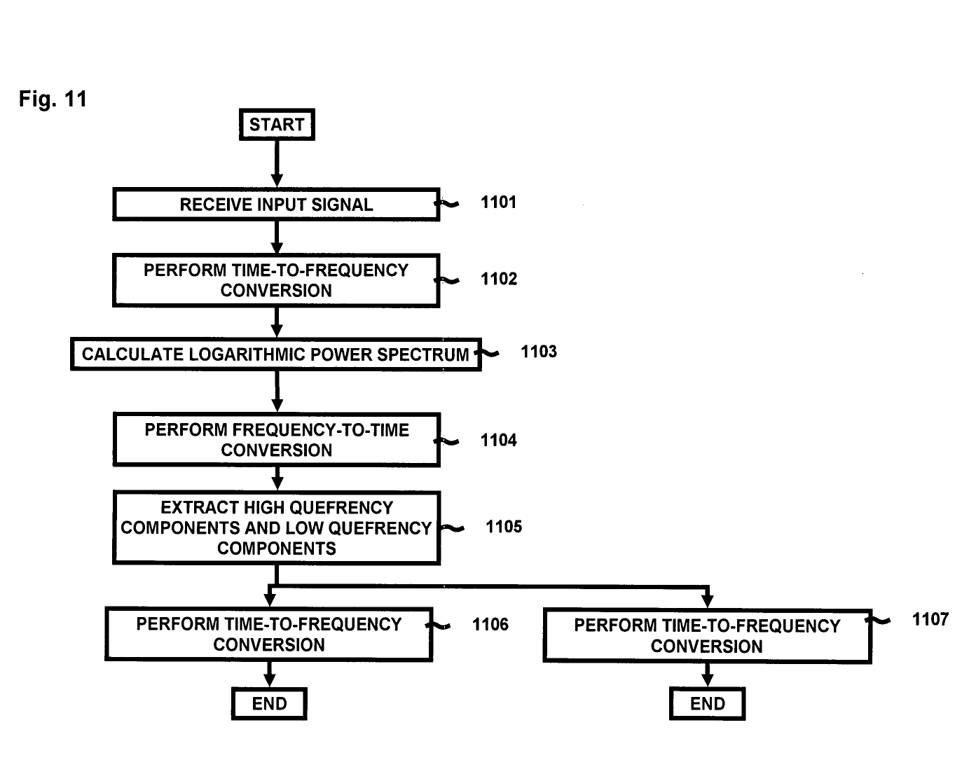

The information processing device 600 generates the pseudo sound by repeating the sound source of the sound included in the input signal with the length of an integral multiple of the period of the sound source and applying the envelope of the sound to the sound source. The analysis unit 601 calculates the envelope of the sound and the sound source of the sound in accordance with a procedure for calculating the envelope of the sound and the sound source of the sound, which is illustrated in FIG. 11.

The analysis unit 601 calculates the envelope of the sound included in the input signal, the sound source of the sound, the periodicity of the sound source of the sound, and feature quantity of the noise on the basis of the error information and the input signal of the normal section input from outside the information processing device 600.

Then, the analysis unit 601 inputs the envelope of the sound, the sound source of the sound, and the periodicity of the sound source of the sound to the pseudo sound generation unit 602. The pseudo sound generation unit 602 generates the pseudo sound by repeating the sound source of the sound included in the input signal with the length of the integral multiple of the period of the sound source of the sound and applying the envelope of the sound to the sound source. Further, the analysis unit 601 inputs the feature quantity of the noise to the pseudo noise generation unit 603. The pseudo noise generation unit 603 generates the pseudo noise on the basis of the feature quantity of the noise.

The pseudo sound generation unit 602 inputs the pseudo sound to the output signal generation unit 604. The pseudo noise generation unit 603 inputs the pseudo noise to the output signal generation unit 604. Further, the analysis unit 601 inputs the periodicity of the sound source of the sound and the feature quantity of the noise to the output signal generation unit 604. The output signal generation unit 604 acquires the error information and the input signal from outside the information processing device 600. Then, the output signal generation unit 604 generates the output signal.

### Configuration Diagram of Information Processing Device 700

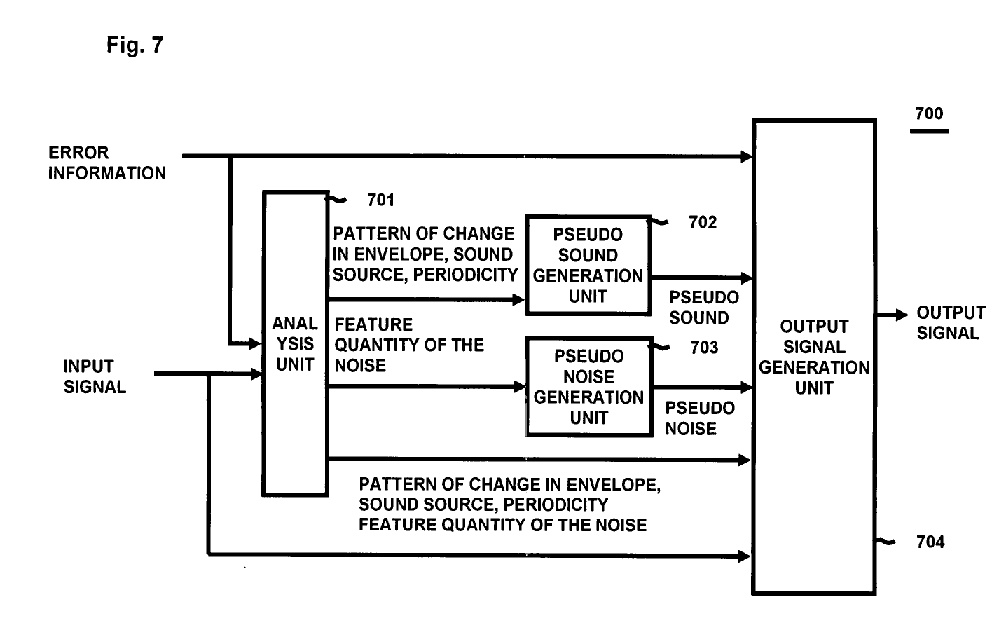

FIG. 7 is a configuration diagram of the information processing device 700 according to one of the present embodiments.

The information processing device 700 is constituted by analysis unit 701, pseudo sound generation unit 702, pseudo noise generation unit 703, and output signal generation unit 704.

The information processing device 700 generates the pseudo sound by repeating the sound source of the sound included in the input signal with the length of an integral multiple of the period of the sound source of the sound and applying to the sound source the pattern of change in the envelope of the sound.

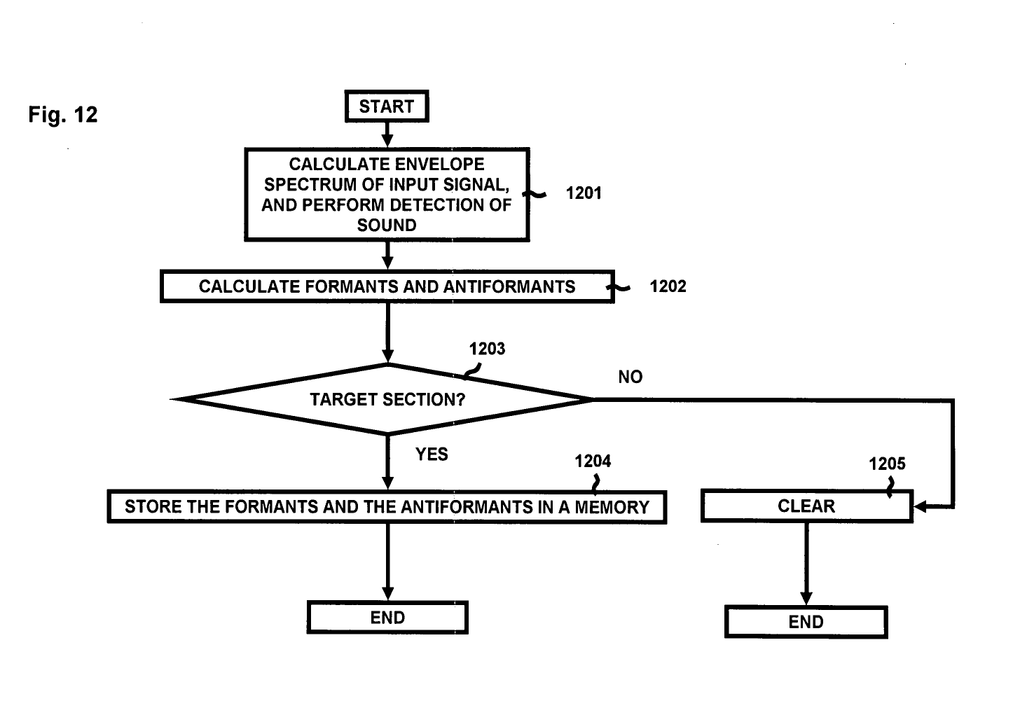

The analysis unit 701 calculates the pattern of change in the envelope of the sound included in the input signal, the sound source of the sound, the periodicity of the sound source of the sound, and the feature quantity of the noise on the basis of the error information and the input signal of the normal section input from outside the information processing device 700. The analysis unit 701 calculates the envelope of the sound and the sound source of the sound in accordance with the procedure for calculating the envelope of the sound and the sound source of the sound, which is illustrated in FIG. 11. Further, the analysis unit 701 calculates the pattern of change in the envelope of the sound in accordance with a procedure for calculating the pattern of change in the envelope of the sound, which is illustrated in FIG. 12.

Then, the analysis unit 701 inputs the pattern of change in the envelope of the sound, the sound source of the sound, and the periodicity of the sound source of the sound to the pseudo sound generation unit 702. The pseudo sound generation unit 702 generates the pseudo sound by repeating the sound source of the sound included in the input signal with the length of the integral multiple of the period of the sound source of the sound and applying to the sound source the pattern of change in the envelope of the sound. Further, the analysis unit 701 inputs the feature quantity of the noise to the pseudo noise generation unit 703. The pseudo noise generation unit 703 generates the pseudo noise on the basis of the feature quantity of the noise.

The pseudo sound generation unit 702 inputs the pseudo sound to the output signal generation unit 704. The pseudo noise generation unit 703 inputs the pseudo noise to the output signal generation unit 704. Further, the analysis unit 701 inputs the periodicity of the sound source of the sound and the feature quantity of the noise to the output signal generation unit 704. The output signal generation unit 704 acquires the error information and the input signal from outside the information processing device 700. Then, the output signal generation unit 704 generates the output signal.

### Procedure of Interpolation Process by Information Processing Devices 100 to 700

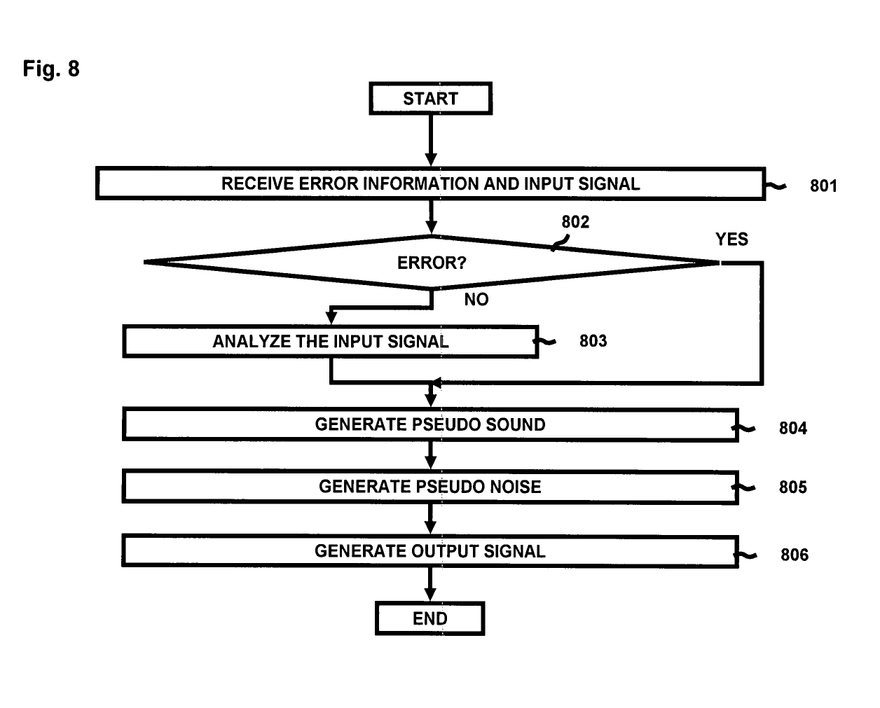

FIG. 8 is a flowchart of the interpolation process performed by the information processing devices 100 to 700 illustrated in FIGS. 1 to 7. The flowchart of the interpolation process illustrates schematic process steps performed by the information processing devices 100 to 700.

The information processing devices 100 to 700 are devices for performing the interpolation for the signal loss occurring in the transmission of sound through digital signals. Particularly, the information processing devices 100 to 700 according to the present embodiments are devices for performing the interpolation for the packet loss occurring in the transmission of sound in a packet switching network. Further, the information processing devices 100 to 700 receive the input signal frame by frame.

The information processing devices 100 to 700 receive the error information and the input signal of the current frame input to the information processing devices 100 to 700 (Step 801). The input signal is a frame-by-frame digital signal representing the sound and the background noise.

The information processing devices 100 to 700 determine the presence or absence of an error in the current frame on the basis of the error information (Step 802). The error information is the information representing the section in which the packet loss has occurred. The presence of the error indicates that the packet loss has occurred in the input signal, i.e., the packet is “absent.”

If the information processing devices 100 to 700 determine the absence of the error in the current frame (NO at Step 802), the information processing devices 100 to 700 analyze the input signal (Step 803). More specifically, the analysis unit 101 to 701 included in the information processing devices 100 to 700 analyze the input signal to calculate the feature quantity of the sound and the feature quantity of the background noise. The information processing devices 100 to 700 generate the pseudo sound and the pseudo noise (Steps 804 and 805). Then, the information processing devices 100 to 700 generate the output signal by combining together the pseudo sound and the pseudo noise (Step 806).

If the information processing devices 100 to 700 determine the presence of the error in the current frame (YES at Step 802), the information processing devices 100 to 700 generate the pseudo sound (Step 804). Then, the information processing devices 100 to 700 generate the pseudo noise (Step 805). The information processing devices 100 to 700 generate the output signal by combining (superimposing) together the pseudo sound and the pseudo noise (Step 806).

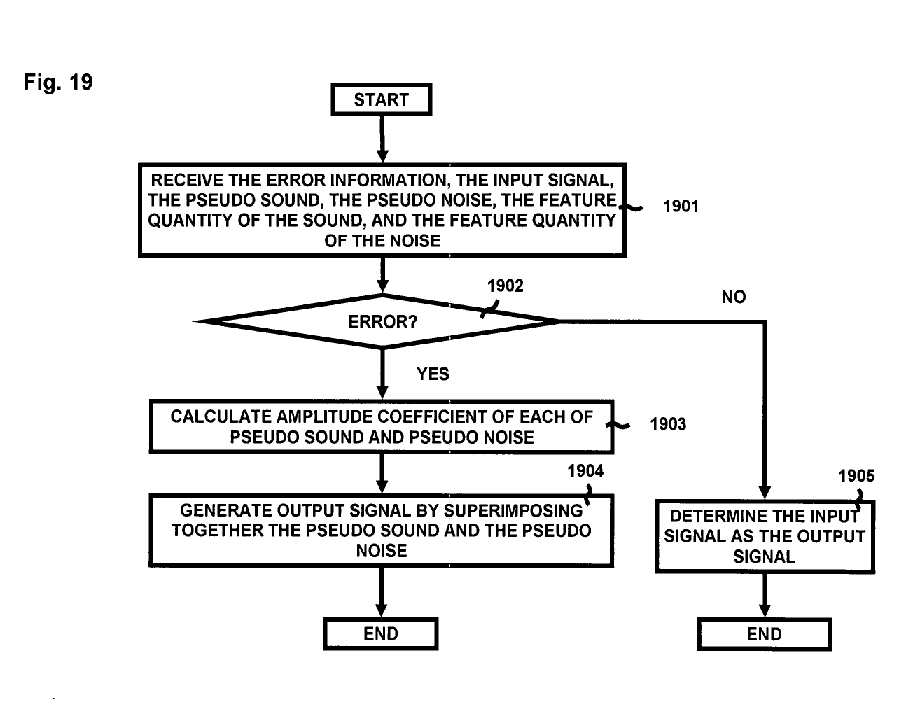

The information processing devices 100 to 700 generate the pseudo sound and the pseudo noise irrespective of the presence or absence of the packet loss (the presence or absence of the error). Then, if the packet loss is absent, the information processing devices 100 to 700 output the input signal as the output signal (see Step 1905 in FIG. 19). Frequency characteristic of background noise

FIG. 9 is a flowchart illustrating the processing procedure for calculating the frequency characteristic of the background noise performed by the analysis unit 101 to 701 according to the present embodiments.

The analysis unit 101 to 701 perform the detection of the sound in the input signal (Step 901). Specifically, the analysis unit 101 to 701 perform the detection of the sound in the input signal by comparing the power of the frame with the average power of the noise. Then, the analysis unit 101 to 701 determine whether or not the sound has been detected (Step 902). If the analysis unit 101 to 701 have detected the sound (YES at Step 902), the analysis unit 101 to 701 calculate the power spectrum of the background noise (Step 905). The calculation of the power spectrum of the background noise is also performed when the analysis unit 101 to 701 have not detected the sound (NO at Step 902). In this case, the analysis unit 101 to 701 perform time-to-frequency conversion on the input signal (Step 903). Specifically, the analysis unit 101 to 701 perform fast Fourier transform or the like. The time-to-frequency conversion is conversion in which the input signal is decomposed for each frequency and converted from the time domain to the frequency domain. Similarly, the frequency-to-time conversion described later is conversion for converting the input signal from the frequency domain to the time domain. The analysis unit 101 to 701 calculate the power spectrum of the input signal (the current frame) from Formula (F1) (Step 904). Herein, pᵢ, reᵢ, and imᵢ represent the power spectrum (dB) of the i-th band, the real part (dB) of the spectrum of the i-th band, and the imaginary part (dB) of the spectrum of the i-th band, respectively.

Formula 1

pᵢ=pᵢ=10 log 10 reᵢ²+imᵢ² (F1)

Then, the analysis unit 101 to 701 calculate the power spectrum of the background noise (Step 905). The analysis unit 101 calculates the power spectrum of the background noise of the current frame by weighting and averaging the power spectrum of the current frame and the power spectrum of the background noise of the preceding frame. If the analysis unit 101 to 701 have detected the sound (YES at Step 902), the power spectrum of the background noise of the current frame is calculated to be equal to the power spectrum of the background noise of the preceding frame. Herein, nᵢ, prev_nᵢ, and coef represent the power spectrum (dB) of the background noise of the i-th band, the power spectrum (dB) of the background noise of the i-th band in the preceding frame, and the weighting factor of the current frame, respectively.

Formula 2

nᵢ=prev_{—}nᵢ*(1−coef)+p₁*coef (F2)

Alternatively, the analysis unit 101 to 701 may determine the frequency characteristic of the background noise by using an adaptation algorithm, such as a learning identification method. That is, the analysis unit 101 to 701 may calculate the frequency characteristic of the background noise as the filter coefficient learned to minimize the error between the filtered white noise and the background noise.

### Procedure for Calculating Periodicity

The periodicity calculated by the analysis unit 101 to 701 is the periodicity of the input signal, the signal of the sound component, or the sound source of the sound. In the present embodiments, the periodicity refers to the period of the target signal (the input signal, the signal of the sound component, or the sound source of the sound) and the strength of the periodicity. In the present embodiments, the strength of the periodicity is represented by the value of the maximum autocorrelation coefficient. The analysis unit 101 to 701 calculate the autocorrelation coefficient of the target signal from Formula (F3). Then, the analysis unit 101 to 701 calculate, as the period, the length of a displacement position of the signal for maximizing the autocorrelation coefficient. Herein, the period and the periodicity are represented as a_max and MAX(corr(a)), respectively. Further, x, M, and a represent the target signal for which the periodicity is calculated, the length (the sample) of the section for which the correlation coefficient is calculated, and the start position of the signal for which the correlation coefficient is calculated, respectively. Further, corr(a), a_max, and i represent the correlation coefficient obtained when the displacement position is represented by the value a, the value of a corresponding to the maximum correlation coefficient (the position maximizing the autocorrelation coefficient), and the index (the sample) of the signal, respectively.

Formula 3

$$corr ( a ) = \frac{{\sum }_{i = 0}^{M - 1} x ( i - a ) x ( i )}{\sqrt{{\sum }_{i = 0}^{M - 1} {x ( i - a )}^{2} \sqrt{{\sum }_{i = 0}^{M - 1} {x ( i )}^{2}}}} \qquad ( F3 )$$

### Procedure for Calculating Sound Component

The analysis unit 501 illustrated in FIG. 5 calculates the sound component of the input signal. FIG. 10 is a flowchart of the procedure for calculating the sound component performed by the analysis unit 501 according to one of the present embodiments. Description will be made below of the procedure for calculating the sound component of the input signal performed by the analysis unit 501.

The analysis unit 501 receives the input signal input to the information processing device 500, and performs the detection of the sound and the calculation of the power spectrum of the background noise (Step 1001). The detection of the sound and the calculation of the power spectrum of the background noise are performed in accordance with the processing procedure for calculating the frequency characteristic of the background noise illustrated in FIG. 9.

Then, the analysis unit 501 determines whether or not the sound has been detected in the current frame (Step 1002). If the analysis unit 501 has detected the sound in the current frame (YES at Step 1002), the analysis unit 501 performs the time-to-frequency conversion on the input signal (Step 1003). The analysis unit 501 calculates the power spectrum of the input signal (Step 1004). The power spectrum of the input signal is calculated from Formula (F1) The analysis unit 501 calculates the power spectrum of the sound (Step 1005). The analysis unit 501 calculates the power spectrum of the sound by subtracting the power spectrum of the background noise calculated at Step 1001 from the power spectrum of the input signal calculated at Step 1004. Alternatively, the analysis unit 501 may be configured to calculate the power spectrum of the sound component by calculating the SNR (signal-to-noise ratio) from the ratio between the power spectrum of the input signal and the power spectrum of the background noise and determining the ratio of the sound component included in the input signal in accordance with the SNR.

The analysis unit 501 performs the frequency-to-time conversion on the power spectrum of the sound (Step 1006). In the present embodiment, inverse Fourier transform is performed as the frequency-to-time conversion. Accordingly, the analysis unit 501 obtains, as the sound component, the signal converted to the time domain.

Further, if the analysis unit 501 has not detected the sound in the current frame (NO at Step 1002), the analysis unit 501 completes the process of calculating the sound component of the input signal.

### Procedure for Calculating Envelope of Sound and Sound Source of Sound

The analysis unit 601 and 701 illustrated in FIGS. 6 and 7 calculate the envelope of the sound in the input signal and the sound source of the sound. FIG. 11 is a flowchart of the procedure for calculating the envelope of the sound and the sound source of the sound performed by the analysis unit 601 and 701 each according to one of the present embodiments.

The analysis unit 601 and 701 receive the input signal input to the information processing devices 600 and 700, respectively (Step 1101). The analysis unit 601 and 701 perform the time-to-frequency conversion on the input signal (Step 1102). Then, the analysis unit 601 and 701 calculate the logarithmic power spectrum of the input signal (Step 1103).

The analysis unit 601 and 701 perform the frequency-to-time conversion on the logarithmic power spectrum of the input signal (Step 1104). The analysis unit 601 and 701 extract high quefrency components and low quefrency components from a signal obtained through the frequency-to-time conversion performed on the logarithmic power spectrum of the input signal (Step 1105). The dimension of the quefrencies is time.

Then, the analysis unit 601 and 701 perform the time-to-frequency conversion on the high quefrency components to calculate the envelope of the sound (Step 1106). Further, the analysis unit 601 and 701 perform the time-to-frequency conversion on the low quefrency components to calculate the sound source of the sound (Step 1107).

### Procedure for Calculating Envelope Pattern of Sound

The analysis unit 701 illustrated in FIG. 7 calculates the envelope pattern of the sound of the input signal. FIG. 12 is a flowchart of the procedure for calculating the envelope pattern of the sound performed by the analysis unit 701 according to one of the present embodiments.

The analysis unit 701 calculates the envelope spectrum of the input signal, and performs the detection of the sound (Step 1201).

The analysis unit 701 calculates formants and antiformants (Step 1202). The formants represent the maximum points of the envelope spectrum, while the antiformants represent the minimum points of the envelope spectrum.

The analysis unit 701 determines whether or not the current frame is the target section for which the envelope pattern is to be recorded (Step 1203). If the total number of the formants and the antiformants included in the current frame is equal to or less than a threshold value in a section, or if the sound has not been detected in a section, the analysis unit 701 determines that the section is not the recording target section. That is, the analysis unit 701 determines, as the recording target section, the section in which the total number of the formants and the antiformants included in the current frame is greater than the threshold value.

If the analysis unit 701 determines that the current frame is the recording target section (YES at Step 1203), the analysis unit 701 stores the formants and the antiformants in a memory (Step 1204). In the present example, the analysis unit 701 has the memory for storing the formants and the antiformants.

Meanwhile, if the analysis unit 701 determines that the current frame is not the recording target section (NO at Step 1203), the analysis unit 701 clears the stored formants and antiformants from the memory (Step 1205).

### First Procedure for Generating Pseudo Sound

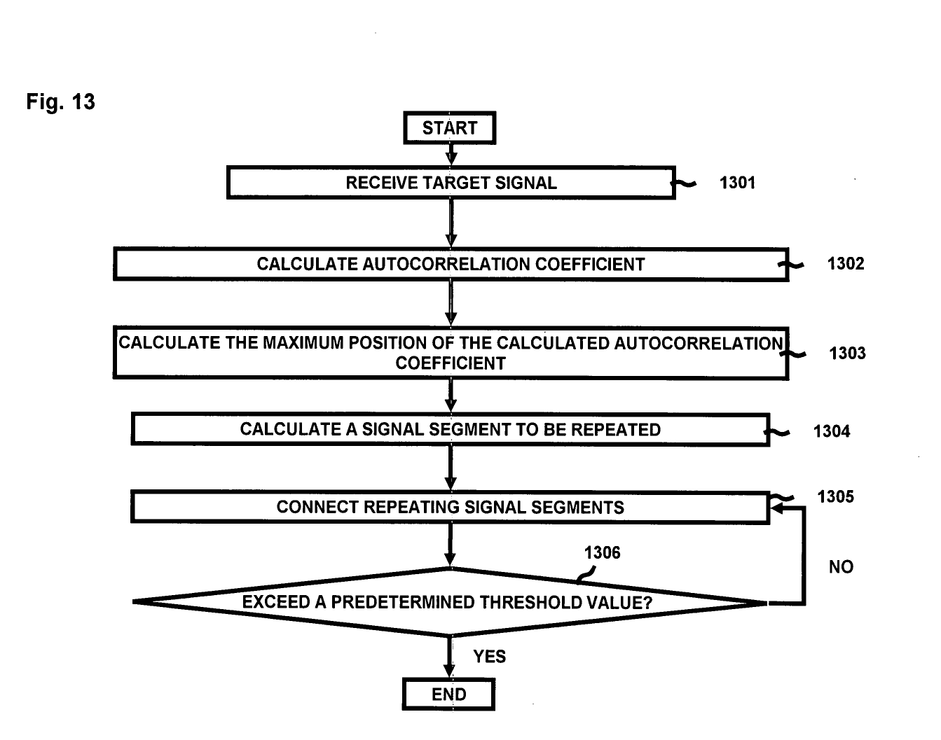

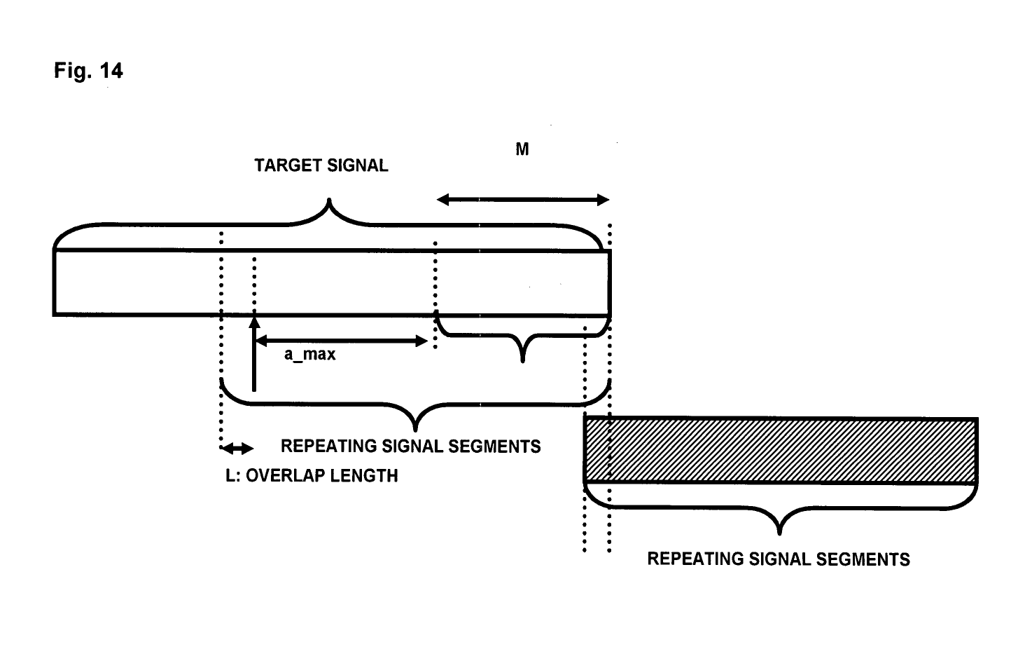

FIG. 13 is a flowchart of a procedure for generating the pseudo sound performed by the pseudo sound generation unit 102 to 502 each according to one of the present embodiments. Further, FIG. 14 is a schematic diagram illustrating a connection relationship between repeating signal segments according to one of the present embodiments. Herein, M represents the length (the sample) of the section for which the correlation coefficient is calculated, while L represents the overlapping length.

The pseudo sound generation unit 102 to 502 receive the target signal to be repeated from the analysis unit 101 to 501, respectively (Step 1301). The target signal to be repeated is the input signal of the normal section or the signal of the sound component of the normal section. The normal section refers to the section in which the error has not occurred, i.e., the section in which the packet loss has not occurred.

With the use of Formula (F3), the pseudo sound generation unit 102 to 502 calculate the autocorrelation coefficient of the target signal to be repeated (Step 1302). To calculate the periodicity of the pseudo sound (the period and the strength of the periodicity of the pseudo sound), the pseudo sound generation unit 102 to 502 calculate the autocorrelation coefficient of the target signal to be repeated.

Then, the pseudo sound generation unit 102 to 502 calculate the maximum position of the calculated autocorrelation coefficient (Step 1303). The maximum position of the autocorrelation coefficient is represented as a_max, and corresponds to the period.

The pseudo sound generation unit 102 to 502 calculate a signal segment to be repeated (Step 1304). Herein, the signal segment to be repeated is a segment extending to the end of the target signal from the position ahead of an autocorrelation coefficient start position by the distance of a sample corresponding to the value a_max+L.

The pseudo sound generation unit 102 to 502 connect and repeat the repeating signal segments (Step 1305). Herein, the pseudo sound generation unit 102 to 502 sequentially connect the repeating signal segments such that a sample corresponding to the value L is overlapped between the adjacent repeating signal segments. With the repeating signal segments connected together with the overlapped portions, the pseudo sound for preventing the occurrence of the abnormal sound can be generated. With the use of Formula (F4), the pseudo sound generation unit 102 to 502 calculate a signal OL reflecting the result of the overlapping of the connected signal segments. Herein, Sl(j) represents a chronologically earlier (left-side) signal to be connected, and Sr(j) represents a chronologically later (right-side) signal to be connected. Further, j represents the number designating a sample, and ranges from zero to L-1.

Formula 4

$$OL ( j ) = ( \frac{L - j}{L} ) Sl ( j ) + \frac{j}{L} Sr ( j ) \qquad ( F4 )$$

The pseudo sound generation unit 102 to 502 calculate a signal length obtained as the result of the repeating (the result of the connection) of the repeating signal segments, and determine whether or not the signal length has exceeded a predetermined threshold value (Step 1306).

If the pseudo sound generation unit 102 to 502 determine that the signal length obtained as the result of the repeating has exceeded the predetermined threshold value (YES at Step 1306), the pseudo sound generation unit 102 to 502 complete the process of generating the pseudo sound. Meanwhile, if the pseudo sound generation unit 102 to 502 determine that the signal length obtained as the result of the repeating has not exceeded the predetermined threshold value (NO at Step 1306), the pseudo sound generation unit 102 to 502 continue to connect the repeating signal segments (Step 1305).

### Second Procedure for Generating Pseudo Sound

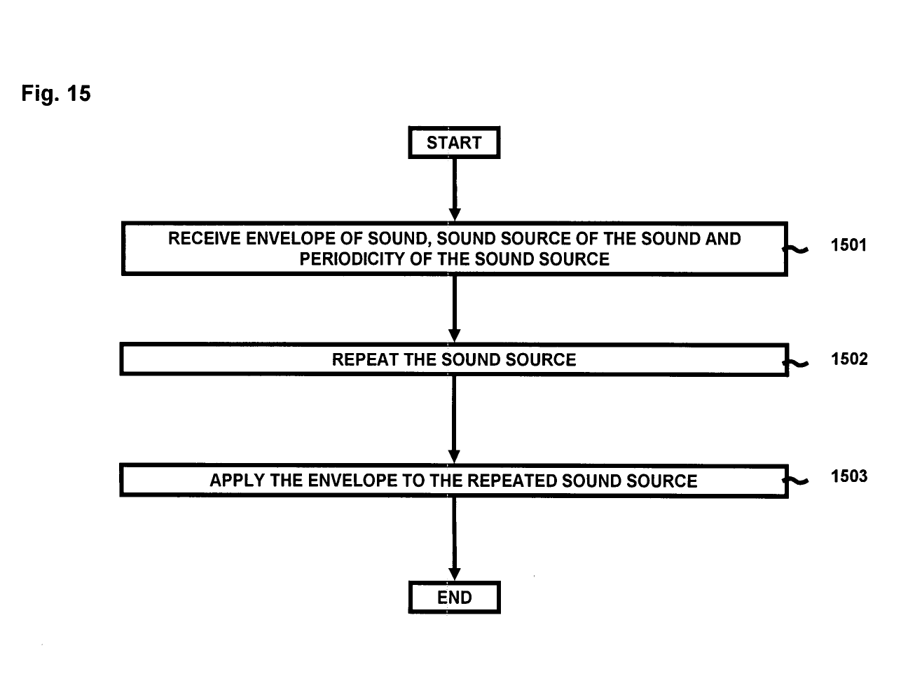

FIG. 15 is a flowchart of a procedure for generating the pseudo sound performed by the pseudo sound generation unit 602 according to one of the present embodiments.

The pseudo sound generation unit 602 receives the envelope of the sound. Further, the pseudo sound generation unit 602 receives the sound source of the sound and the periodicity of the sound source (Step 1501).

The pseudo sound generation unit 602 repeats the sound source to generate one frame of the sound source (Step 1502). The pseudo sound generation unit 602 repeats the sound source in accordance with the processing flow illustrated in FIG. 13 to generate one frame of the sound source. The pseudo sound generation unit 602 applies the envelope to the repeated sound source to generate the pseudo sound (Step 1503). Herein, the pseudo sound generation unit 602 employs the following method as the method for applying the envelope to the repeated sound source. The pseudo sound generation unit 602 performs the time-to-frequency conversion on the repeated sound source to calculate an amplitude spectrum O(k). Then, the pseudo sound generation unit 602 multiplies the calculated amplitude spectrum O(k) by an amplitude spectrum E(k) of the envelope to calculate an amplitude spectrum S(k) of the pseudo sound (see Formula (F5)). Herein, S(k), O(k), and E(k) represent the amplitude spectrum of the pseudo sound of the k-th band, the amplitude spectrum of the repeated sound source of the k-th band, and the amplitude spectrum of the envelope of the k-th band, respectively. The pseudo sound generation unit 602 returns S(k) to the time domain through the frequency-to-time conversion.

Formula 5

S(k)=O(k)*E(k) (F5)

Third procedure for Generating Pseudo Sound

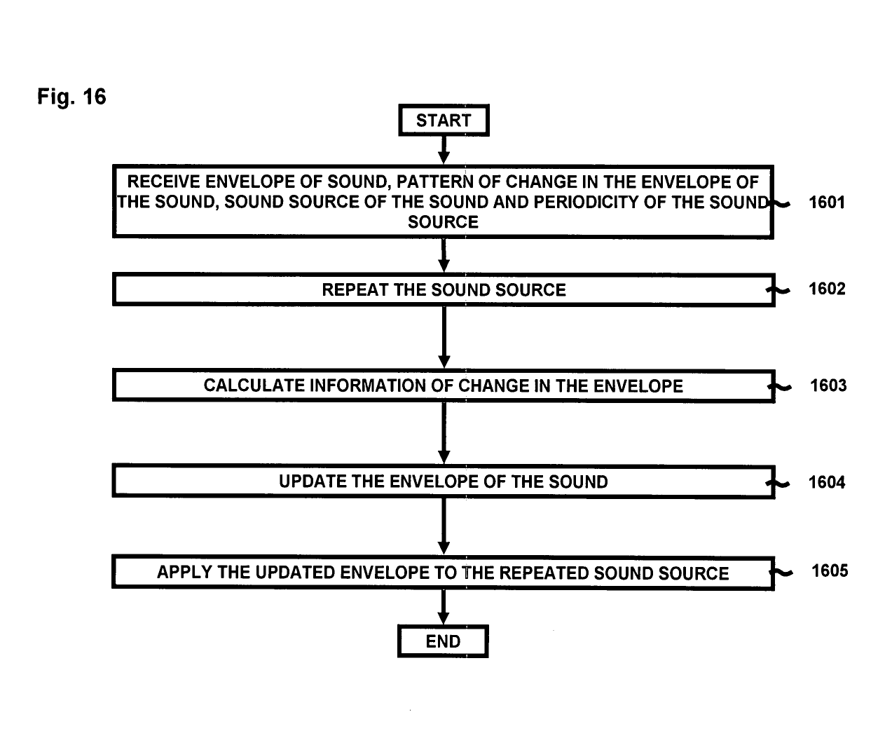

FIG. 16 is a flowchart of a procedure for generating the pseudo sound performed by the pseudo sound generation unit 702 according to one of the present embodiments.

The pseudo sound generation unit 702 receives from the analysis unit 701 the envelope of the sound and the pattern of change in the envelope of the sound. Further, the pseudo sound generation unit 702 receives the sound source of the sound and the periodicity of the sound source (Step 1601).

The pseudo sound generation unit 702 repeats the sound source in accordance with the processing flow illustrated in FIG. 13 to generate one frame of the sound source (Step 1602).

The pseudo sound generation unit 702 calculates the information of change in the envelope from the pattern of change in the envelope of the sound (Step 1603). The pseudo sound generation unit 702 calculates the information of change according to the following method. On the basis of envelope information at a time t and a time t+1, the pseudo sound generation unit 702 calculates the information of change in the envelope occurring between the time t and the time t+1. Herein, the envelope information represents the frequency (Hz) and the amplitude (db) of each of the formants and the antiformants. The frequency and the amplitude of the first formant at the time t are assumed to be F1x and F1y, respectively. Further, the frequency and the amplitude of the first formant at the time t+1 are assumed to be (F1x+Δx) and (F1y+Δy), respectively. Accordingly, the information of change in the first formant (px, py) is represented as px=Δx/x and py=Δy/y. In a similar manner, the information of change is calculated for the other formants and antiformants. Then, the information of change in all formants and antiformants is integrated to represent the information of change in the envelope.

The pseudo sound generation unit 702 updates the envelope of the sound by using the information of change in the envelope (Step 1604). The pseudo sound generation unit 702 calculates the formants and antiformants of the envelope of the sound. The pseudo sound generation unit 702 updates the formants and antiformants by applying the corresponding information of change to each of the formants and antiformants. Then, the pseudo sound generation unit 702 calculates the width corresponding to each of the formants and antiformants. The width of each of the formants is the difference between two frequencies which are located on the right side and left side of the formant, respectively, and at which the power spectrum first falls below the power spectrum of the formant by a predetermined value. Herein, the predetermined value is 3 dB, for example. Similarly, the width of each of the antiformants is the difference between two frequencies which are located on the right side and left side of the antiformant, respectively, and at which the power spectrum first exceeds the power spectrum of the antiformant by a predetermined value. Specifically, when the frequency and the amplitude of the first formant are F1_cur_x and F1_cur_y, respectively, the frequency F1_cur_x′ and the amplitude F1_cur_y′ of the updated first formant can be represented as F1_cur_x′=F1_cur_x*px and F1_cur_y′=F1_cur_y*py, respectively. The other formants and antiformants can be updated in a similar manner. The pseudo sound generation unit 702 calculates the envelope of the sound by applying a quadratic curve to each of the formants and antiformants. The quadratic curve applied to each of the formants by the pseudo sound generation unit 702 is a quadratic curve having maximum coordinates (fx, fy) and passing through coordinates (fx+0.5 WF, fy−3). Herein, (fx, fy) and WF (Hz) represent the position and the width of the formant, respectively. Further, the x-axis and the y-axis represent the frequency (Hz) and the power (dB), respectively. Similarly, the quadratic curve applied to each of the antiformants by the pseudo sound generation unit 702 is a quadratic curve having minimum coordinates (ux, uy) and passing through coordinates (ux+0.5 UF, uy+3). Herein, (ux, uy) and UF (Hz) represent the position and the width of the antiformant, respectively. Further, the pseudo sound generation unit 702 interpolates the quadratic curve corresponding to the formant and the quadratic curve corresponding to the antiformant to calculate the envelope of the border between the formant and the antiformant.

The pseudo sound generation unit 702 applies the updated envelope to the repeated sound source to generate the pseudo sound (Step 1605). The pseudo sound generation unit 702 generates the pseudo sound by employing a method similar to the method employed by the pseudo sound generation unit 602. That is, the pseudo sound generation unit 702 calculates the amplitude spectrum O(k) by performing the time-to-frequency conversion on the repeated sound source. The pseudo sound generation unit 702 multiplies the calculated amplitude spectrum O(k) by the amplitude spectrum E(k) of the envelope to calculate the amplitude spectrum S(k) of the pseudo sound (see Formula (F5)). Then, the pseudo sound generation unit 702 returns S(k) to the time domain through the frequency-to-time conversion to generate the pseudo sound.

### First Procedure for Generating Pseudo Noise

FIG. 17 is a flowchart illustrating the procedure for generating the pseudo noise performed by the pseudo noise generation unit 203 according to one of the present embodiments.

The pseudo noise generation unit 203 generates the white noise (Step 1701).

With the use of Formula (F6), the pseudo noise generation unit 203 applies to the white noise the filter coefficient representing the frequency characteristic of the background noise, to thereby generate the pseudo noise (Step 1702). Herein, y(n), w(n), h(m), n, and m represent the pseudo noise, the white noise, the filter coefficient, the number of samples, and the filter order ranging from zero to p−1, respectively.

Formula 6

$$y ( n ) = {\sum }_{m = 0}^{p - 1} h ( m ) w ( n - m ) \qquad ( F6 )$$

### Second Procedure for Generating Pseudo Noise

FIG. 18 is a flowchart of the procedure for generating the pseudo noise performed by the pseudo noise generation unit 303 according to one of the present embodiments.

The pseudo noise generation unit 303 receives the power spectrum of the background noise from the analysis unit 301 (Step 1801).

The pseudo noise generation unit 303 randomizes the phase of the spectrum of the background noise (Step 1802). Specifically, the pseudo noise generation unit 303 randomizes the phase of the background noise while maintaining the magnitude of the amplitude spectrum of the background noise. The amplitude spectrum, the real part of the spectrum of each band, and the imaginary part of the spectrum of each band are represented as s(i), re(i), and im(i), respectively. The pseudo noise generation unit 303 replaces re(i) and im(i) with random numbers re′(i) and im′(i), respectively, and multiplies the random numbers re′(i) and im′(i) by a coefficient to maintain the magnitude of the amplitude spectrum, to thereby calculate the spectrum of the phase-randomized background noise ((αre′(i), αim′(i)). Accordingly, the pseudo amplitude spectrum can be calculated from Formula (F7).

Formula 7

s(i)={square root over ((αre′(i))²+(αim′(i))² )} (F7)

Then, the pseudo noise generation unit 303 returns the spectrum of the phase-randomized background noise ((αre′(i), αim′(i)) to the time domain through the frequency-to-time conversion to generate the pseudo noise (Step 1803).

### Procedure for Generating Output Signal

FIG. 19 is a flowchart of a procedure for generating the output signal performed by the output signal generation unit 104 to 704 according to the present embodiments.

The output signal generation unit 104 to 704 receive the error information, the input signal, the pseudo sound, the pseudo noise, the feature quantity of the sound, and the feature quantity of the noise (Step 1901).

The output signal generation unit 104 to 704 determine the presence or absence of the error on the basis of the information received at Step 1901 (Step 1902).

If the output signal generation unit 104 to 704 determine the presence of the error in the current frame (YES at Step 1902), the output signal generation unit 104 to 704 calculate the amplitude coefficient of each of the pseudo sound and the pseudo noise (Step 1903). The output signal generation unit 104 to 704 generate the output signal by superimposing together the pseudo sound and the pseudo noise (Step 1904).

If the output signal generation unit 104 to 704 determine the absence of the error in the current frame (NO at Step 1902), the output signal generation unit 104 to 704 determine the input signal as the output signal (Step 1905).

### First Procedure for Calculating Amplitude Coefficient

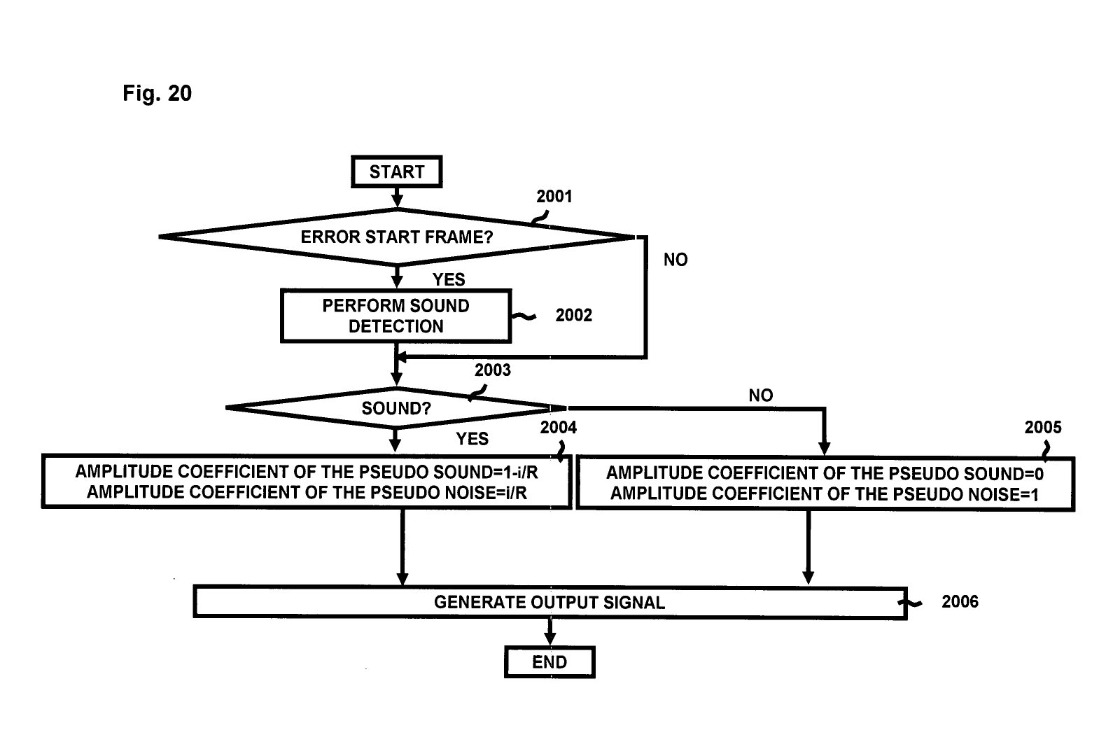

FIG. 20 is a flowchart illustrating a first procedure for calculating the amplitude coefficient performed by the output signal generation unit 104 to 704 according to the present embodiments.

The output signal generation unit 104 to 704 determine whether or not the current frame is an error start frame (Step 2001). The error start frame refers to the frame in which the frame loss (the packet loss) has first occurred in a section in which the frame loss has occurred. If the output signal generation unit 104 to 704 determine that the current frame is the error start frame (YES at Step 2001), the output signal generation unit 104 to 704 perform the sound detection process on the input signal (Step 2002). The sound detection process is the process of determining the sound according to whether or not the power of the input signal has exceeded a threshold value. Meanwhile, if the output signal generation unit 104 to 704 determine that the current frame is not the error start frame (NO at Step 2001), the output signal generation unit 104 to 704 determine the presence or absence of the sound in the current frame (Step 2003).

At Step 2003, the output signal generation unit 104 to 704 determine whether or not the sound has been detected (Step 2003). If the output signal generation unit 104 to 704 have detected the sound (YES at Step 2003), the output signal generation unit 104 to 704 calculate the amplitude coefficient of the pseudo sound and the amplitude coefficient of the pseudo noise as 1−i/R and i/R, respectively (Step 2004). Herein, R and i represent the number of samples required to adjust the amplitude of the pseudo sound to zero and the number of samples appearing after the start of the error, respectively. The value R is a preset value which has been previously determined. Meanwhile, if the output signal generation unit 104 to 704 have not detected the sound (NO at Step 2003), the output signal generation unit 104 to 704 calculate the amplitude coefficient of the pseudo sound and the amplitude coefficient of the pseudo noise as zero and one, respectively (Step 2005).

The output signal generation unit 104 to 704 generate the output signal by adding together the pseudo sound multiplied by the amplitude coefficient therefor and the pseudo noise multiplied by the amplitude coefficient therefor (Step 2006). Herein, the output signal generation unit 104 to 704 perform adjustment such that the intra-frame average amplitude of the input signal immediately preceding the error becomes equal to the intra-frame average amplitude of the output signal obtained by adding together the pseudo sound multiplied by the amplitude coefficient therefor and the pseudo noise multiplied by the amplitude coefficient therefor.

### Second Procedure for Calculating Amplitude Coefficient

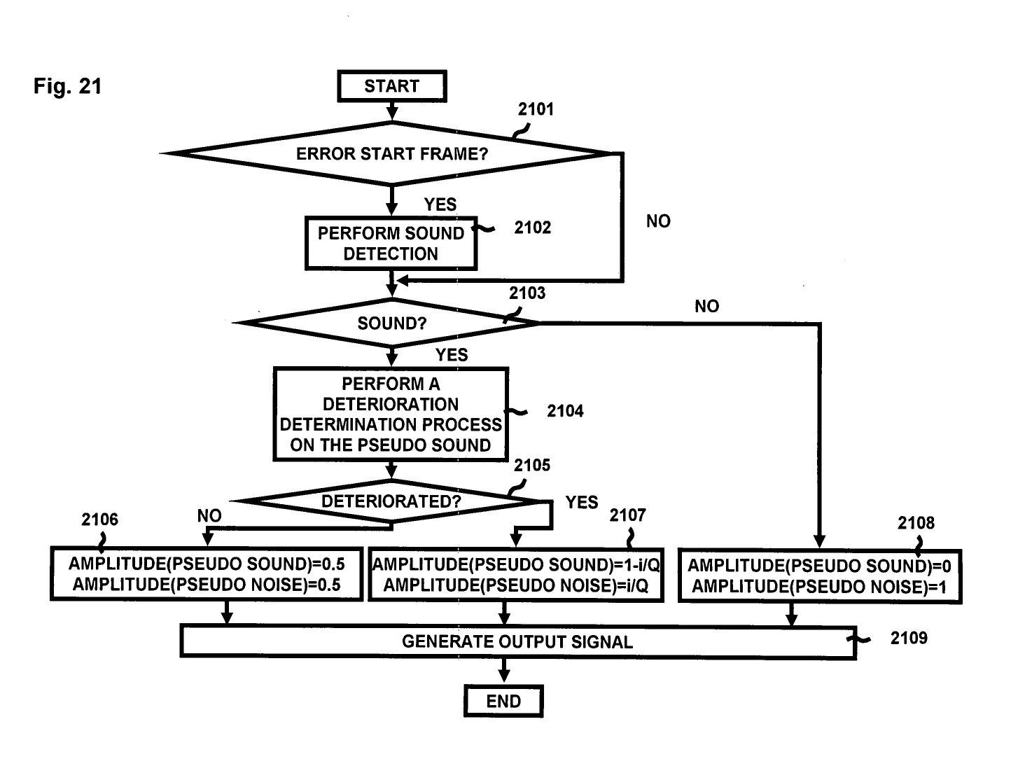

FIG. 21 is a flowchart illustrating a second procedure for calculating the amplitude coefficient performed by the output signal generation unit 104 to 704 according to the present embodiments.

The output signal generation unit 104 to 704 determine whether or not the current frame is the error start frame (Step 2101). If the output signal generation unit 104 to 704 determine that the current frame is the error start frame (YES at Step 2101), the output signal generation unit 104 to 704 perform the sound detection process on the input signal (Step 2102). The sound detection process according to the present embodiment is also the process of determining the sound according to whether or not the power of the input signal has exceeded the threshold value. Meanwhile, if the output signal generation unit 104 to 704 determine that the current frame is not the error start frame (NO at Step 2101), the output signal generation unit 104 to 704 determine the presence or absence of the sound in the current frame.

The output signal generation unit 104 to 704 determine whether or not the sound has been detected (Step 2103). If the output signal generation unit 104 to 704 have detected the sound (YES at Step 2103), the output signal generation unit 104 to 704 perform a deterioration determination process on the pseudo sound (Step 2104).

The output signal generation unit 104 to 704 determine whether or not the pseudo sound has been deteriorated (Step 2105). If the output signal generation unit 104 to 704 determine that the pseudo sound has not been deteriorated (NO at Step 2105), the output signal generation unit 104 to 704 calculate the amplitude coefficient of the pseudo sound and the amplitude coefficient of the pseudo noise as 0.5 and 0.5, respectively (Step 2106). If the output signal generation unit 104 to 704 determine that the pseudo sound has been deteriorated (YES at Step 2105), the output signal generation unit 104 to 704 calculate the amplitude coefficient of the pseudo sound and the amplitude coefficient of the pseudo noise as 1−i/Q and i/Q, respectively (Step 2107). Herein, Q and i represent the number of samples required to adjust the amplitude of the pseudo sound to zero after the determination of the deterioration of the pseudo sound and the number of samples appearing after the determination of the deterioration of the pseudo sound, respectively. Further, the amplitude coefficient of the pseudo sound may be weighted as follows by the periodicity of the input signal, the periodicity of the sound component, or the periodicity of the sound source. For example, the amplitude coefficient of the pseudo sound may be weighted as (1−i/Q)*MAX(corr(a)).

At Step 2103, if the output signal generation unit 104 to 704 have not detected the sound (NO at Step 2103), the output signal generation unit 104 to 704 calculate the amplitude coefficient of the pseudo sound and the amplitude coefficient of the pseudo noise as zero and one, respectively (Step 2108).

The output signal generation unit 104 to 704 generate the output signal by adding together the pseudo sound multiplied by the amplitude coefficient therefor and the pseudo noise multiplied by the amplitude coefficient therefor (Step 2109). Herein, the output signal generation unit 104 to 704 perform adjustment such that the intra-frame average amplitude of the input signal immediately preceding the error becomes equal to the intra-frame average amplitude of the output signal obtained by adding together the pseudo sound multiplied by the amplitude coefficient therefor and the pseudo noise multiplied by the amplitude coefficient therefor.

### Procedure for Determining Deterioration of Pseudo Sound

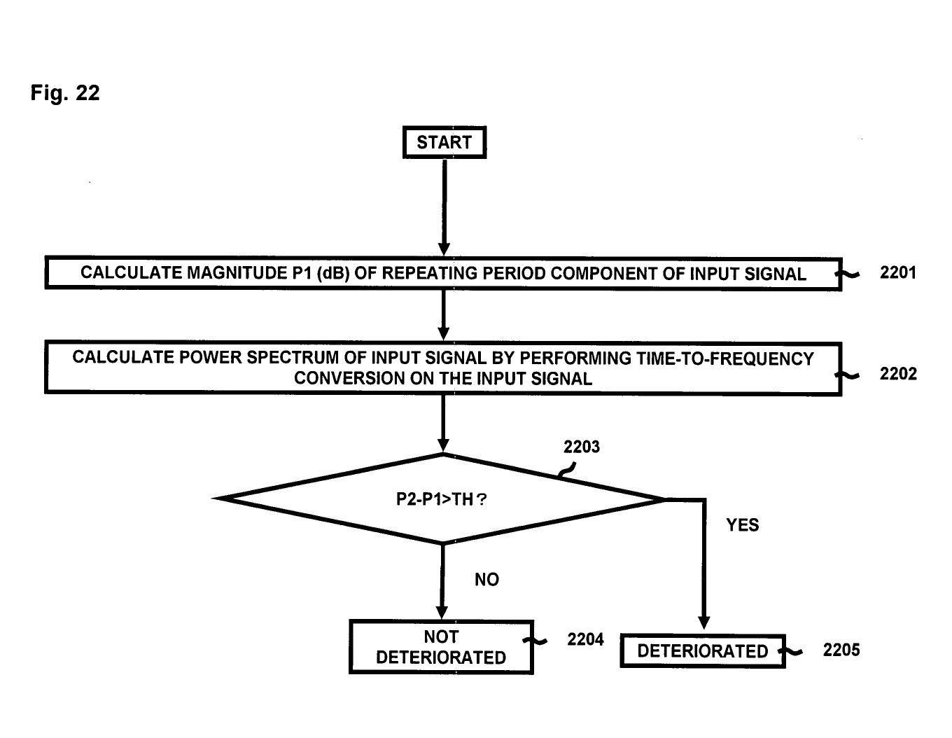

FIG. 22 is a flowchart illustrating the process of determining the deterioration of the pseudo sound performed by the output signal generation unit 104 to 704 according to the present embodiments.

The output signal generation unit 104 to 704 calculate the magnitude P1 (dB) of the repeating period component of the input signal (Step 2201). The output signal generation unit 104 to 704 calculate the power spectrum of the input signal by performing the time-to-frequency conversion on the input signal. Then, on the basis of the power spectrum of the input signal, the output signal generation unit 104 to 704 calculate the magnitude (the power) P1 of the repeating period component of the input signal.

The output signal generation unit 104 to 704 calculate the magnitude P2 (dB) of the repeating period component of the pseudo sound (Step 2202). The output signal generation unit 104 to 704 calculate the power spectrum of the pseudo sound by performing the time-to-frequency conversion on the pseudo sound. Then, on the basis of the power spectrum of the pseudo sound, the output signal generation unit 104 to 704 calculate the magnitude (the power) P2 of the repeating period component of the pseudo sound.

The output signal generation unit 104 to 704 subtract the magnitude P1 of the repeating period component of the input signal from the magnitude P2 of the repeating period component of the pseudo sound to calculate the value P2−P1. Then, the output signal generation unit 104 to 704 determine whether or not the value P2−P1 has exceeded a preset predetermined threshold value (Step 2203). If the output signal generation unit 104 to 704 determine that the value P2−P1 has not exceeded the preset predetermined threshold value (NO at Step 2203), the output signal generation unit 104 to 704 determine that the pseudo sound has not been deteriorated (Step 2204). Meanwhile, if the output signal generation unit 104 to 704 determine that the value P2−P1 has exceeded the preset predetermined threshold value (YES at Step 2203), the output signal generation unit 104 to 704 determine that the pseudo sound has been deteriorated (Step 2205).

### Functions of Information Processing Devices 100 to 700

The information processing devices 100 to 700 according to the present embodiments separately generate the pseudo sound and the pseudo noise on the basis of the feature quantity of the sound included in the input signal and the feature quantity of the noise included in the input signal. Accordingly, even if the signal immediately preceding the packet loss is a signal having a small periodicity, such as the signal of a consonant, background noise, and so forth, it is possible to perform interpolation for the packet loss while reducing the deterioration of the sound quality caused by abnormal sound and so forth generated by the occurrence of an unnatural period.

In the above-described manner, the information processing devices 100 to 700 according to the present embodiments analyze the input signal to calculate the feature quantity of the sound included in the input signal and the feature quantity of the background noise included in the input signal. The information processing devices 100 to 700 separately generate the pseudo sound and the pseudo noise by using the feature quantity of the sound and the feature quantity of the background noise. Further, the information processing devices 100 to 700 generate the output signal by distributing the pseudo sound and the pseudo noise in accordance with the characteristics of the input signal. Accordingly, it is possible to perform interpolation which suppresses the deterioration of the sound quality and thus provides high sound quality.

Further, the information processing device 200 according to one of the present embodiments generates the pseudo noise by using the frequency characteristic of the background noise. Accordingly, it is possible to generate the pseudo noise without causing discontinuation of the sound quality and the power of the pseudo noise from the sound quality and the power of the background noise superimposed on the input signal.

Further, the information processing device 400 calculates the periodicity of the input signal. Therefore, the distribution of the pseudo sound can be determined in accordance with the periodicity of the input signal. Accordingly, particularly when the periodicity of the input signal is small, the information processing device 400 can suppress abnormal sound attributed to the repetition of the target signal.

Further, the information processing device 500 according to one of the present embodiments calculates the periodicity of the sound component of the input signal. Therefore, the distribution of the pseudo sound can be determined in accordance with the periodicity of the sound component of the input signal. Accordingly, particularly when the periodicity of the sound component of the input signal is small, the information processing device 500 can suppress abnormal sound attributed to the repetition of the target signal (the sound component of the input signal). Further, the information processing device 500 repeats only the sound component of the input signal. Therefore, abnormal sound attributed to the periodic repetition of the superimposed noise can be suppressed.

Further, the information processing devices 600 and 700 calculate the periodicity of the sound source of the sound. Therefore, the distribution of the pseudo sound can be determined in accordance with the periodicity of the sound source of the sound. Accordingly, when the periodicity of the sound source of the sound is small, the information processing devices 600 and 700 can suppress abnormal sound attributed to the repetition of the target signal.

Further, the information processing device 700 calculates the pattern of change in the envelope of the sound. Therefore, the pseudo sound can be generated with the use of the pattern of change in the envelope of the sound. Accordingly, the information processing device 700 can generate more natural pseudo sound, and thus can perform high-quality interpolation.

What is claimed is:

1. A method for interpolating a partial loss of an audio signal including a sound signal component and a background noise component in transmission thereof, the method comprising the steps of:
calculating frequency characteristic of the background noise in the audio signal;
extracting the sound signal component from the audio signal;
generating pseudo noise by applying the frequency characteristic of the background noise included in the audio signal to white noise; and
generating an interpolation signal by combining the pseudo noise with the extracted sound signal component included in the audio signal to supersede the partial loss of the audio signal.

2. The method of claim 1; wherein the frequency characteristic of background noise is power spectrum of background noise.

3. The method of claim 1 further comprising the steps of:
calculating frequency characteristic of the audio signal immediately before the loss of the audio signal.

4. The method of claim 1 further comprising the steps of:
calculating a periodicity of the audio signal,

5. The method of claim 4 further comprising the steps of:
generating pseudo sound by repeating the audio signal with a length of an integral multiple of the periodicity of the audio signal.

6. The method of claim 1 further comprising the steps of;
calculating an envelope of the sound signal component, the sound source of the sound signal component, and the periodicity of the sound signal component.

7. The method of claim 6 further comprising the steps of:
generating the pseudo sound on the basis of the envelope of the sound signal component and the sound source of the sound signal component.

8. The method of claim 6 further comprising the steps of:
calculating a pattern of change in the envelope of sound of the sound signal component, the sound source of the sound signal component, and the periodicity of the sound source.

9. The method of claim 8 further comprising the steps of:
generating the pseudo sound on the basis of the pattern of change in the envelope of the sound signal component, the sound source of the sound signal component, and the periodicity of the sound source.

10. An information processing device for interpolating a partial loss of an audio signal including a sound signal component and a background noise component in transmission thereof, the information processing device comprising:
a receiving unit for receiving the audio signal;
a processor for performing a process of interpolating the partial loss of the audio signal comprising the steps of:
calculating frequency characteristic of the background noise in the audio signal;
extracting the sound signal component from the audio signal;
generating pseudo noise by applying the frequency characteristic of the background noise included in the audio signal to white noise; and
generating an interpolation signal by combining the pseudo noise with the extracted sound signal component included in the audio signal to supersede the partial loss of the audio signal;
an output unit for outputting the interpolation signal.
